(19) United States
(12) Patent Application Publication
(10) Pub. No.: US 2008/0098766 A1
(43) Pub. Date: May 1, 2008

(54) Method and apparatus for directed distribution of ice onto a cold plate

(75) Inventor: William A. Edwards, Selma, TX (US)

Correspondence Address: LAW OFFICES OF CHRISTOPHER L. MAKAY, 1634 Milam Building, 115 East Travis Street, San Antonio, TX, 78205, US

(73) Assignee: Lancer Partnership, Ltd.

(21) Appl. No.: 11/590,411

(22) Filed: Oct. 31, 2006

(51) Int. Cl. B67D 5/62

(52) U.S. Cl. 62/396; 62/398

(57) ABSTRACT

A product dispenser including a divider having at least one inlet zone recharge aperture disposed above an inlet zone of a cold plate, and at least one outlet zone recharge aperture disposed above an outlet zone of the cold plate, allows increased amounts of ice stored above the divider to be directed onto the inlet zone to compensate for an increased temperature of the inlet zone. The inlet zone recharge aperture is of a greater area than the outlet zone recharge aperture, or in the case of multiple apertures, the areas of like zone recharge apertures are combined to ensure that increased ice flow is delivered to the inlet zone. A method for distributing increased ice flow to the inlet zone to deliver chilled fluids within consumption specifications is also provided.

### BACKGROUND OF THE INVENTION

1. Field of the Invention

The present invention relates to product dispensing equipment and, more particularly, but not by way of limitation, to methods and an apparatus for optimal distribution of ice onto a cold plate disposed within a product dispenser.

2. Description of the Related Art

In the areas of product dispensing, product dispensers with cooling capability must include either a refrigeration system or be cooled by ice. Product dispensers with refrigeration systems typically place the refrigeration coils in a water bath with any beverage or concentrate flow circuits that require chilling. As heat is removed from the refrigeration coils, the temperature of the coils drops below freezing, and the water adjacent to the refrigeration coils turns to ice, thereby building an ice block that chills the water bath. The water bath then chills the product and diluent lines that pass through the water bath, as well as the product passing through the product lines.

Ice cooled devices typically include a cold plate disposed beneath a storage chamber for ice. At times, the cold plate may function as a floor of the storage chamber, thereby allowing any stored ice to come into contact with the cold plate. As the ice in contact with the cold plate melts, it is replaced with ice directly above the cold plate. Alternatively, a shroud having apertures may be utilized as a liner for the ice storage chamber, wherein the liner is disposed a predetermined distance above the cold plate. The apertures may then be utilized to regulate the amount of ice that comes into contact with the cold plate, thereby extending the life expectancy of the ice disposed within the storage chamber.

While the practice of utilizing apertures in a shroud to dispense ice cubes onto an upper surface of a cold plate may seem routine, the evolution of ice shapes and forms have forced beverage dispenser manufacturers to reevaluate cold plate cooling methods, as conventional methods may no longer be adequate. Illustratively, smaller cubes sizes have an increased surface area per unit volume, and therefore may have an increased melt rate. An increased melt rate may exhaust ice on a cold plate faster than it can be replenished, thereby raising an operating temperature of the cold plate slightly. Continued drawing of drink dispenses at a sub standard cooling level translates to an increased cold plate temperature, and a higher than normal drink dispense temperature. A shift of a few degrees in the temperature of the cold plate may move dispensed drink temperatures outside of an acceptable drink temperature specification, thereby rendering any dispensed drinks unusable.

Further, the shapes of ice particles may limit their ability to flow freely. Ice cubes tend to flow or spread more easily than smaller ice particles. Smaller ice particles also clump more readily when manipulated, and therefore create other handling problems when moving from a storage container to an upper surface of a cold plate. Placement of non-flowing ice onto a less than desirable area of the upper surface of the cold plate may prove ineffective in cooling the cold plate, similarly resulting in an above normal cold plate temperature.

Accordingly, a product dispensing system that is able to direct virtually any shape or form of ice onto a cold plate to cool the cold plate, as well as products flowing therethrough would be beneficial to beverage dispenser manufacturers, retail establishments, and consumers.

### SUMMARY OF THE INVENTION

In accordance with the present invention, a product dispenser includes a divider having at least one inlet zone recharge aperture disposed above an inlet zone of a cold plate, and at least one outlet zone recharge aperture disposed above an outlet zone of the cold plate. In this preferred embodiment, the cold plate inlets fluids at an inlet portion disposed beneath the inlet zone, and outlets fluids at an outlet portion disposed beneath the outlet zone. The at least one inlet zone recharge aperture is of a greater area than the at least one outlet zone recharge aperture, thereby directing increased amounts of a product stored above the divider to the inlet zone of the cold plate to compensate for increased temperatures of the inlet portion of the cold plate.

The present invention extends to and includes the use of multiple inlet zone recharge apertures, relief areas, cutouts, and openings that may allow the passage of the product from above the divider to an area beneath the divider and above the cold plate. In the case of multiple inlet zone apertures, areas of the individual inlet zone recharge apertures may be summed up to determine an overall inlet zone recharge aperture area. Likewise, multiple outlet zone recharge apertures may be summed up to arrive at a total outlet zone recharge aperture area. Once calculated, the total areas may be adjusted to force an increased ice flow to the inlet zone of the cold plate.

A method for distributing ice onto a cold plate is also provided, wherein increased ice flow to the inlet zone of the cold plate compensates for increased inlet portion temperatures to deliver chilled fluids within dispensing industry specifications.

It is therefore an object of the present invention to provide a product dispenser that delivers increased ice flow to the inlet zone of the cold plate, thereby compensating for an increased temperature of the inlet portion of the cold plate.

It is a further object of the present invention to provide a product dispenser including a divider having an inlet zone recharge aperture with a greater area than an outlet zone recharge aperture, thereby delivering an increased ice flow through the inlet zone recharge aperture.

It is still further an object of the present invention to provide a method for delivering increased ice flow to the inlet zone of the cold plate, thereby compensating for increased temperatures of the inlet portion of the cold plate.

Still other objects, features, and advantages of the present invention will become evident to those of ordinary skill in the art in light of the following. Also, it should be understood that the scope of this invention is intended to be broad, and any combination of any subset of the features, elements, or steps described herein is part of the intended scope of the invention.

### BRIEF DESCRIPTION OF THE DRAWINGS

FIG. 1a provides a perspective view of components required for directing ice onto a cold plate according to a preferred embodiment.

FIG. 1b provides a perspective view of components required for directing ice onto a cold plate utilizing multiple apertures according to the preferred embodiment.

FIG. 1c provides a method flowchart illustrating the process of distributing an increased ice flow onto an inlet portion of the cold plate.

FIG. 2a provides a perspective view of a product dispenser according to the preferred embodiment.

FIG. 2b provides a section view of the product dispenser according to the preferred embodiment.

FIG. 3a provides a section view of a cold plate including product lines according to the preferred embodiment.

FIG. 3b provides a section view of a cold plate including product lines and a carbonator according to the preferred embodiment.

FIG. 4a provides a perspective view of a divider above a cold plate according to the preferred embodiment.

FIG. 4b provides top view of the divider including an increased size delivery passage according to the preferred embodiment.

FIG. 4c provides a top view of the divider including an additional delivery passage according to the preferred embodiment.

### DETAILED DESCRIPTION OF THE PREFERRED EMBODIMENT

As required, detailed embodiments of the present invention are disclosed herein; however, it is to be understood that the disclosed embodiments are merely exemplary of the invention, which may be embodied in various forms. It is further to be understood that the figures are not necessarily to scale, and some features may be exaggerated to show details of particular components or steps.

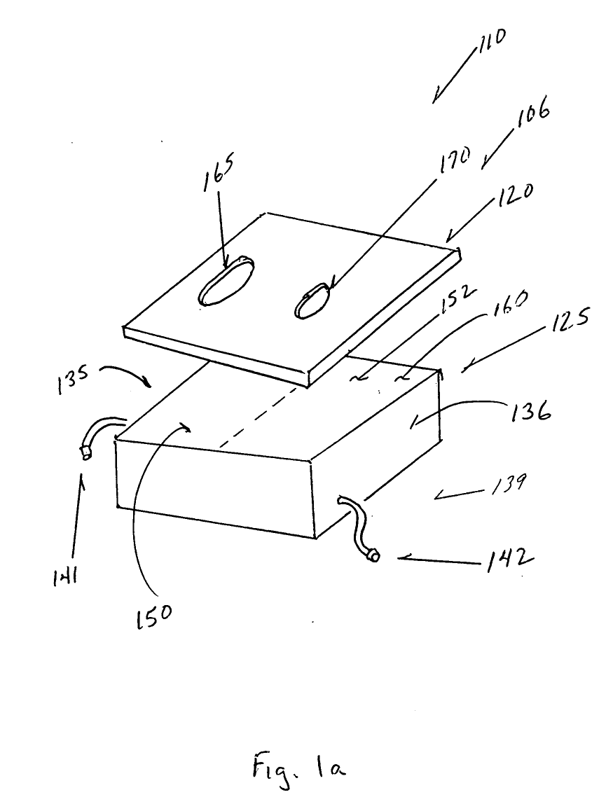

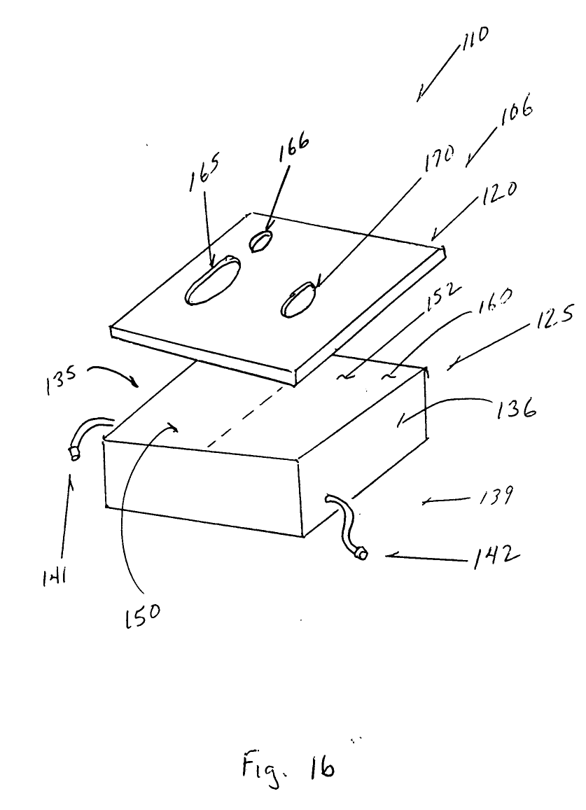

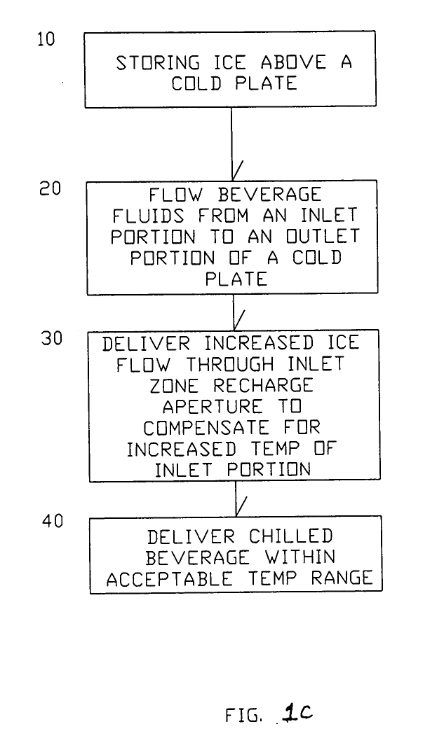

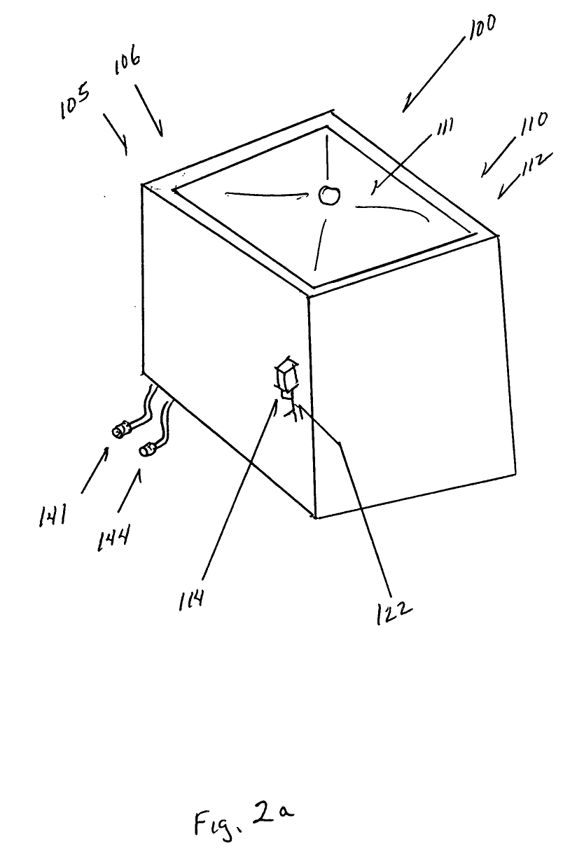

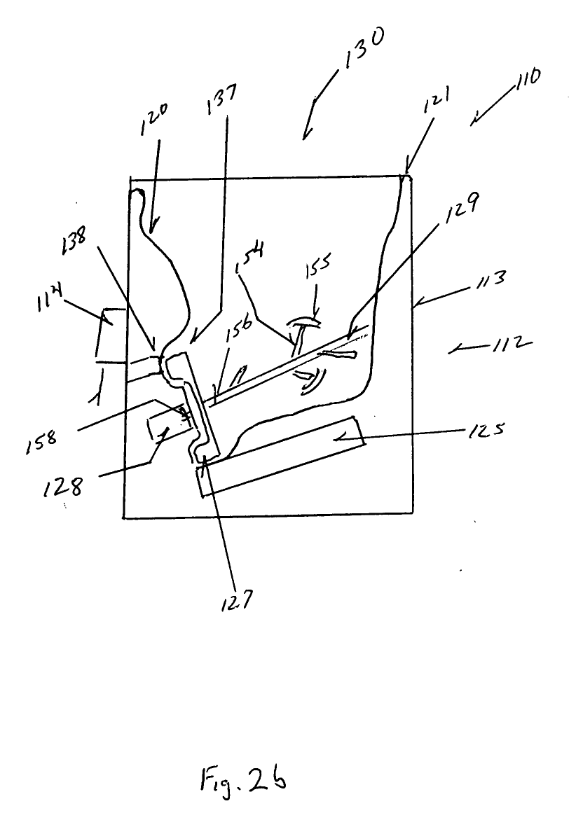

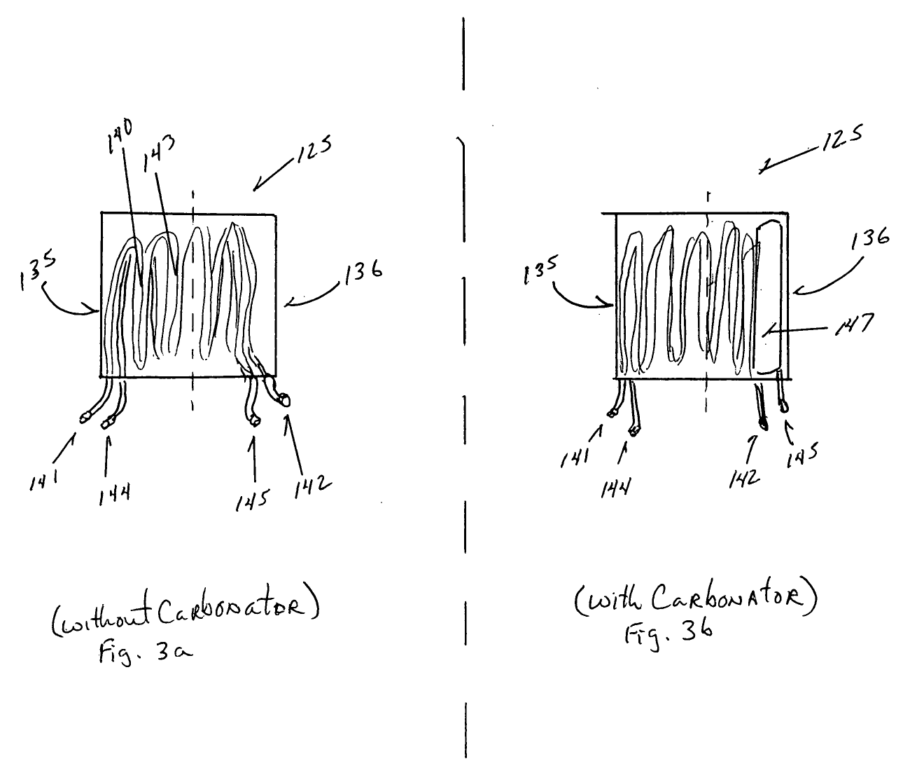

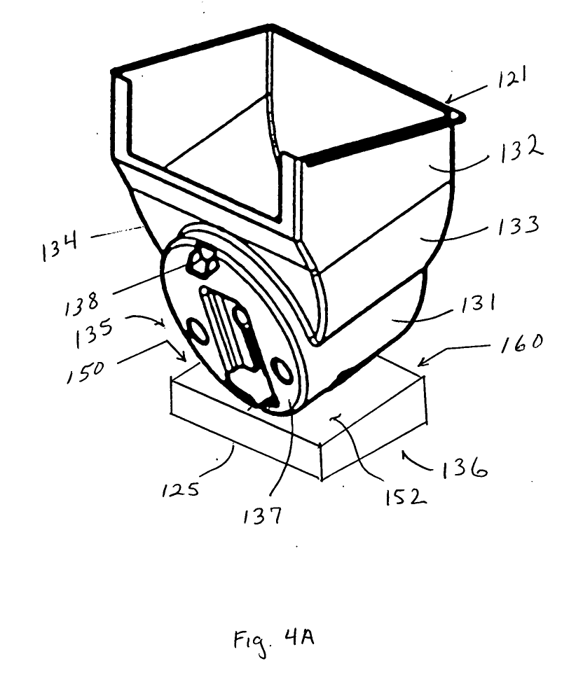

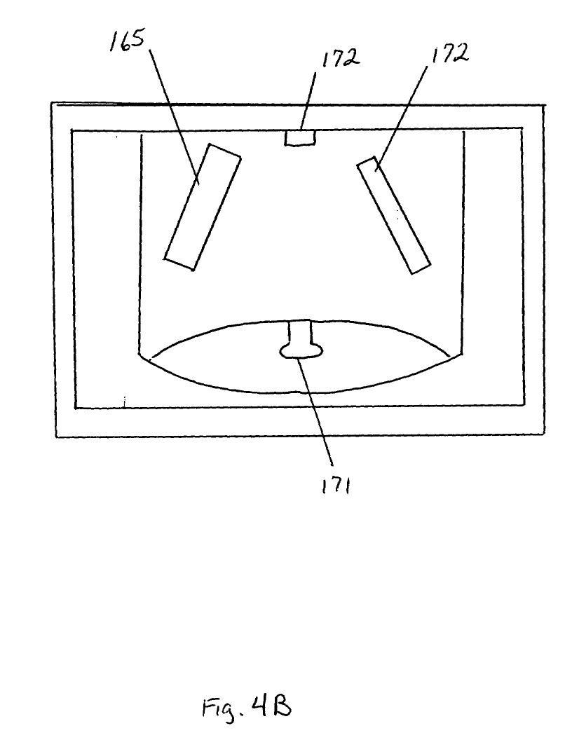

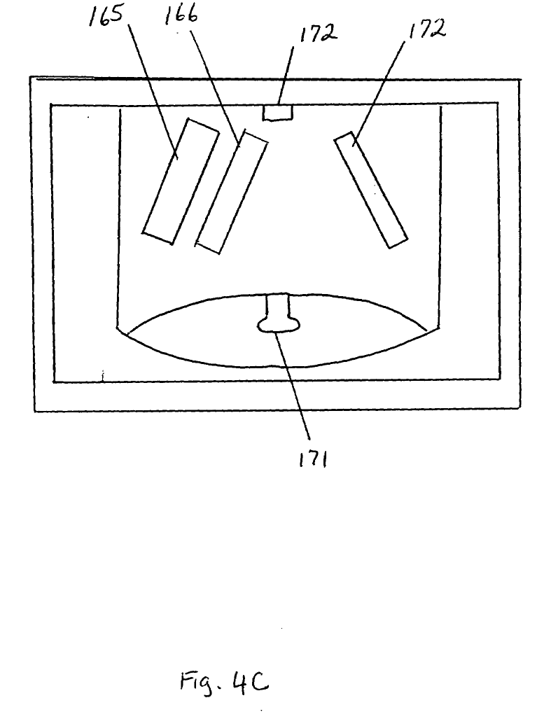

The present invention provides a product dispenser with an increased ice flow capacity to an inlet zone disposed on an upper surface of a cold plate, thereby providing a continued cooling of the cold plate that delivers products within a prescribed temperature range. The product dispenser, accordingly, dispenses any product served below room temperature, which includes, but is not limited to, beverages, waters, juices, teas, and the like. As shown in FIG. 1a, a product dispenser implementing the present invention includes, at a minimum, a housing 110, a cold plate 125 disposed within the housing 110, at least one product flow circuit 106 disposed within the cold plate 125, and a divider 120 disposed above the cold plate 125, wherein a product moves through the product flow circuit 106 to a product valve for delivery through a nozzle.

The cold plate 125 may be any form of heat transfer device commonly utilized to chill product lines and the products disposed within the product lines. In this embodiment, the cold plate 125 is of an aluminum construction with at least one fluid line 139 cast directly into the aluminum. The size of the cold plate 125 may vary with the amount of cooling capacity required in a particular application.

The fluid line 139 from the concentrate flow circuit 106 passes through the cold plate 125. The fluid line 139 includes an inlet 141 and an outlet 142. In this embodiment, the inlet 141 protrudes from an inlet portion 135 of the cold plate 125, and the outlet 142 protrudes from an outlet portion 136 of the cold plate 125. The fluid line 139 makes multiple runs within the cold plate 125 to increase the length of the cooling loop in contact with the cold plate 125. As shown in FIG. 1a, a dividing line between the inlet portion 135 and the outlet portion 136 is substantially down a midplane of the cold plate 125. While this embodiment discloses a midplane of the cold plate 125 as the dividing line between the inlet portion 135 and the outlet portion 136, one of ordinary skill in the art will recognize that dividing line may be located at substantially any plane between the inlet portion 135 and the outlet portion 136, dependent upon temperature gradients, cooling requirements, and cooling capacities. Illustratively, the trailing end of the inlet portion 135 may lie within a first third to a half of the cold plate 125.

The inlet portion 135 typically is at a temperature higher than the outlet portion 136, because it accepts fluids that are stored at room temperature. Illustratively, the inletting fluids may be within the range of seventy degrees to ninety degrees Fahrenheit. Alternatively, the outlet portion 136 must dispense fluids at temperatures between thirty and forty degrees Fahrenheit, thereby forcing a temperature gradient across the cold plate 125. As such, the inlet portion 135 and outlet portion 136 are at different temperatures, and ice dispersed onto an upper surface 152 of the cold plate 125 melts at different rates, dependent upon its location on the upper surface 152 of the cold plate 125. Accordingly, the upper surface 152 of the cold plate 125 may be divided into an inlet zone 150 disposed over the inlet portion 135, and an outlet zone 160 disposed over the outlet portion 136.

The concentrate flow circuit 106 is connected to a product source. The product source may contain either a full strength or a concentrated product. The product enters the concentrate flow circuit 106 through the inlet 141 of the fluid line 139, and passes through the runs within the cold plate 125. Upon exiting the cold plate 125, the product flows through the fluid line 139 upward toward the product valve. The outlet 142 may be connected to a concentrate inlet port of the product valve, and therefore, delivers the product to the concentrate inlet port of the product valve for delivery to the nozzle. Upon actuation of the product valve, a concentrate stream is delivered through the nozzle. In some cases, the concentrate stream may also be mixed with a diluent.

The divider 120 may be any form of restraint suitable for containing a product a predetermined distance above the upper surface 152 of the cold plate 125. Illustratively, the divider 120 may be a flat sheet, a formed sheet, or a molded component, wherein a product, ice for example, may be stored above the divider 120. In this embodiment, the divider 120 includes at least one inlet zone recharge aperture 165 disposed above the inlet zone 150, and at least one outlet zone recharge aperture 170 disposed above the outlet zone 160, to direct the distribution of the ice disposed above the divider 120 onto the upper surface 152 of the cold plate 125. In this embodiment, the at least one inlet zone recharge aperture 165 is of a greater area than the at least one outlet zone recharge aperture 170. The increased area of the inlet zone recharge aperture 165 provides for delivery of an increased amount of ice to the inlet portion 135 of the cold plate 125. The term apertures in this disclosure is defined to include holes, relief areas, or any other open areas disposed above the cold plate that may permit the passage of ice to the cold plate 125.

In cases where at least one additional inlet zone aperture 166 is utilized as shown in FIG. 1b, the areas of the inlet zone recharge apertures 165 and 166 are combined to arrive at a total inlet zone recharge aperture area. One of ordinary skill in the art will recognize that additional outlet zone recharge apertures 170 may also be utilized for increased dispersion onto the outlet zone 160 of the cold plate 125, and similarly, the areas of the multiple outlet zone recharge apertures 170 may be combined to arrive at a total area for the outlet zone recharge apertures 170. Still further, a portion of the divider 120 may be relieved to permit the flow of ice onto the cold plate 125. In those cases, an overall aperture area disposed above the inlet zone 150 and the outlet zone 160 would include the relieved portions of the divider 120. Accordingly, a total area for the inlet zone recharge apertures 165 and 166 is greater than a combined area of any outlet zone recharge apertures 170.

In use, ice is disposed above the divider 120. Portions of the ice fall through the recharge apertures 165 and 170, thereby landing on the upper surface 152 of the cold plate 125. Various actions may push ice disposed near the recharge apertures 165 and 170, through the recharge apertures 165 and 170, including operators scooping ice for use, the weight of the ice itself may force some ice the recharge apertures 165 and 170, or an agitating means disposed above the divider 120 may force quantities of ice through the recharge apertures 165 and 170 when rotated in a pile of ice. In this fashion, ice continues to move through the recharge apertures 165 and 170, and into the volume directly below the divider 120, and above the cold plate 125. Ice may build in the volume directly above the cold plate 125 if the cooling demands are low, and will eventually form a blanket of ice approximately six inches thick on the upper surface 152 of the cold plate 125. Ice directly in contact with the cold plate 125 melts as heat is transferred from the cold plate 125 to the ice, and the melting ice is replaced by ice particles directly above the melting ice. In this manner, the ice blanket is continually depleted adjacent to the cold plate 125, and then recharged by ice being forced through the recharge apertures 165 and 170, and onto the outer layers of the ice blanket. As previously disclosed, ice disposed onto the inlet zone 150 melts at an increased rate, and therefore, must be replenished at an increased rate to continually remove heat from the cold plate 125.

The increased area of the inlet zone recharge aperture 165 allows more ice to be delivered through the inlet zone recharge aperture 165 to compensate for the increased ice depletion due to the higher temperatures of the inlet portion 135 of the cold plate 125. Incoming fluids routinely enter the cold plate 125 at ambient temperature, and then must be chilled in the cold plate 125. Accordingly, an increased ice flow to the inlet portion 135 is necessary to reach a steady state that is capable of delivering drink dispenses within a prescribed temperature range over extended periods. Upon reaching an equilibrium state, the cold plate 125 is cooled to the point where fluids leaving the cold plate 125 move to the product valve and are delivered within the prescribed temperature range of thirty to forty degrees Fahrenheit.

Illustratively, the inletting of fluids at ambient temperatures, approximately seventy degrees Fahrenheit, to the inlet portion 135 of the cold plate 125 raises the temperature of the inlet portion 135, as well as the average temperature of the cold plate 125. The inletting fluids then move through the cold plate 125 to the outlet portion 136 as ice is directed onto the upper surface 152 of the cold plate 125. As previously disclosed, the fluids outlet from the outlet portion 136 of the cold plate 125 exit at temperatures in the range of thirty to forty degrees Fahrenheit. The ice disposed on the upper surface 152 of the cold plate 125 melts as heat is transferred to the ice blanket. As the inlet portion 135 of the cold plate 125 is at a greater temperature than the outlet portion 136 of the cold plate 125, an increased amount of ice is melted above the inlet portion 135 of the cold plate 125, and accordingly, must be replaced at an increased rate. At ambient temperatures, the amount of ice delivered to the inlet portion 135 may be increased up to approximately one hundred and twenty-five percent the amount delivered to the outlet portion 136 of the cold plate 125. The increased area of the inlet zone recharge apertures 165 provides for delivery of increased amounts of ice to the inlet zone 150 of the cold plate 125.

While this embodiment has been shown with an increased delivery of ice to the inlet zone up to approximately one hundred and twenty five percent above the amount of ice delivered to the outlet zone, one of ordinary skill in the art will recognize that many variables may affect the cooling requirements and capacities of the cold plate 125, including the size of the cold plate 125, the temperature of the fluids entering the cold plate 125, the length of cooling loops disposed within the cold plate 125, the desired temperature of the fluids exiting the cold plate 125, as well as the amount of ice delivered to cool the cold plate 125. Accordingly, the amount of ice dispensed onto the inlet zone 150 to cool the cold plate 125 may further be increased to compensate for varying parameters, such as higher than normal inletting temperatures, higher than normal temperature environments, high volumes of dispensed drinks, and the like.

In a second example, the inletting of fluids at elevated temperatures, ninety degrees Fahrenheit, for example, creates an increased temperature differential across the cold plate 125, as the desired outlet fluid temperatures must remain in the same temperature range of thirty to forty degrees Fahrenheit. The increased temperature of the inletting fluids and the average temperature of the cold plate 125 further increase the melt rate of the ice disposed atop the upper surface 152 of the cold plate 125, particularly the ice disposed on the inlet zone 150 of cold plate 125. In this second example, the amount of ice delivered at the inlet portion 135 of the cold plate 125 may be up to substantially double the amount of ice delivered to the outlet portion 136 of the cold plate 125. In this second example, the inlet zone recharge apertures 165 may be of an increased area to facilitate the increased flow of ice to the inlet zone 150 of the cold plate 125.

While these examples show an increased delivery of ice in the ranges of up to one hundred and twenty five percent, and up to substantially double the amount delivered to the outlet portion 136, one of ordinary skill in the art will recognize that amounts greater than those disclosed are possible, and are therefore considered part of this disclosure.

The concentrate flows from the concentrate source through the inlet 141, thereby entering the fluid line 139. The concentrate flows through the fluid line 139, and enters the cold plate 125 with the fluid line 139. The concentrate is then chilled as it moves through the passes of the fluid line 139 disposed within the cold plate 125, and exits the cold plate 125 with the fluid line 139. The concentrate continues through the fluid line 139 to the concentrate inlet port of the product valve. Upon a dispense command, the concentrate moves through the product valve, and is delivered through the nozzle within the prescribed temperature range.

As shown in the method flowchart of FIG. 1c, the process of directing ice onto a cold plate commences with step 10, wherein ice is stored above a cold plate 125. In this embodiment, the cold plate 125 includes an inlet portion 135 for inletting fluids, and an outlet portion 136 that outlets fluids disposed within the cold plate 125. The cold plate 125 further includes an upper surface 152 that is divided into an inlet zone 150 disposed above the inlet portion 135, and an outlet zone 160 disposed above the outlet portion 136. The process continues with step 20, wherein beverage fluids flow from the inlet portion to the outlet portion for chilling. Step 30 provides for delivering increased amounts of ice to the inlet zone 150 through an inlet zone recharge aperture 165 having an increased area, thereby compensating for an increased melt rate. Upon the delivery of increased amounts of ice to the inlet zone 150, the cold plate 125 cools to an optimal temperature, and fluids exit the cold plate 125 at temperatures acceptable for consumption, step 40.

While this invention has been shown with an increased area for an inlet zone recharge aperture 165, one of ordinary skill in the art will recognize that the increased area of inlet zone recharge aperture 165 extends to, and includes, multiple inlet zone recharge apertures 165, as well as multiple outlet zone recharge apertures 170, such that a combined area of multiple inlet zone recharge apertures 165 is greater than a combined area of outlet zone recharge apertures 170, thereby providing an increased delivery of ice to the inlet zone 150 of the cold plate 125. It should further be noted that a single recharge aperture 165 or 170 may be utilized opposite multiple recharge apertures 165 or 170. Illustratively, a single inlet zone recharge aperture 165 may be utilized with two outlet zone recharge apertures 170, dependent upon specific cooling requirements.

For the sake of disclosure and to more fully describe the present invention, a product dispenser 100 that includes the present invention will be described herein. It should be understood, however, that any product dispenser having a cold plate may employ the invention. The product dispenser 100 is of a type product dispenser commonly utilized in the dispensing industry, and includes a housing 110, at least one diluent flow circuit 105, and at least one concentrate flow circuit 106 disposed within the housing 110, wherein a diluent and a concentrate move through the flow circuits 105 and 106 to a product valve 114 for delivery through a nozzle 122. The product valve 114 may be any type of product valve commonly utilized in the product dispensing industry, wherein a concentrate may be delivered with a diluent for mixing. The product valve 114 is disposed onto a front of the housing 110, such that the nozzle 122 points downward for the delivery of a product, a diluent, or a mixture thereof.

The housing 110 includes a frame assembly 112. The frame assembly 112 may be any form of structure suitable for supporting components of the product dispenser 100. In this embodiment, the frame assembly 112 is a welded steel framework. A drip tray is disposed on the front of the housing 110, and beneath any product valves 114, such that the drip tray collects any drips, spills, or overflows of drink receptacles. A cup rest is disposed at an upper end of the drip tray, such that it supports drink receptacles during filling operations. A spacing between the cup rest and the nozzle 122 is of a size sufficient to accommodate drink receptacles being placed beneath the nozzle 122. A splash plate is disposed onto the front of the housing 110 between the product valve 114 and the drip tray. The splash plate is designed to catch errant flows, and force them downward into the drip tray.

The product dispenser 100 further includes a cold plate 125, a divider 120, and a lid 111. The cold plate 125 is disposed within the housing 110 at an angle of approximately twenty degrees, such that the lowest end is adjacent to the front of the housing 110. The cold plate 125 is further disposed beneath the divider 120, and is of a predetermined distance from the divider 120. In this embodiment, the divider 120 is a shroud formed for use as a liner. The divider 120 includes a storage chamber 130, and is disposed within the housing 110, such that the storage chamber 130 is open to a top of the product dispenser 100. In this example, the divider 120 is constructed from polyethylene, and is of a molded construction. The divider 120 further includes a lip 121 around the opening of the storage chamber 130. The lip 121 engages the frame assembly 112, such that the divider 120 hangs from the frame assembly 112. The storage chamber 130 may be closed out with the lid 111.

The divider 120 further includes a rectangular section 132, a first transition arc 133, a second transition arc 134, and a cylindrical section 131. The rectangular section 132 complements the dimensions of the product dispenser 100, thereby maximizing the cross sectional area at the entrance of the storage chamber 130. The rectangular section 132 then funnels down in size by passing through the first and second transition arcs 133 and 134. The transition arcs 133 and 134 then channel to the cylindrical section 131. The cylindrical section 131 includes a cylindrical inset 137 for accepting a paddlewheel 127. The cylindrical section 131 is disposed at approximately the same angle as the cold plate 125, thereby maintaining a consistent distance from the cold plate 125. The cylindrical section 131 of the divider 120 includes at least one inlet zone recharge aperture 165 disposed above an inlet portion 135 of the cold plate 125, and at least one outlet zone recharge aperture 170 disposed above an outlet portion 136 of the cold plate 125. The divider may further include a first shaft relief aperture 171 and a second shaft relief aperture 172 that provide clearance for the removal of the divider from the product dispenser 100.

In this embodiment, the at least one inlet zone recharge aperture 165 is of a greater area than the at least one outlet zone recharge aperture 170. The increased area of the inlet zone recharge aperture 165 provides for delivery of an increased amount of ice to the inlet portion 135 of the cold plate 125. In cases where at least one additional inlet zone aperture 166 is utilized, the areas of the inlet zone recharge apertures 165 and 166 are combined to arrive at a total inlet zone recharge aperture area. One of ordinary skill in the art will recognize that additional outlet zone recharge apertures 170 may also be utilized for increased dispersion onto the outlet portion 136 of the cold plate 125, and similarly, the areas of the multiple outlet zone recharge apertures 170 may be combined to arrive at a total area for the outlet zone recharge apertures 170. Accordingly, a total area for the inlet zone recharge apertures 165 and 166 is greater than a combined area of any outlet zone recharge apertures 170.

As previously disclosed, the term aperture has been defined to include holes, relief areas, and any other form of opening disposed between the storage chamber and the cold plate 125, wherein the ice may be delivered from the storage chamber 130 to the upper surface 152 of the cold plate 125. Accordingly, this disclosure extends to include virtually all openings between a storage chamber 130 and the cold plate 125, including partial shrouds that segment only a portion of the ice delivered to the storage chamber 130. In the situations including partial shrouds, the open areas may be factored into the total aperture areas as a measure for the delivery of increased ice to the inlet portion 135 of the cold plate 125.

The product dispenser 100 further includes an agitator motor 128, an agitator bar 129, and the paddlewheel 127. The agitator motor 128 is disposed outside of the divider 120 nearest the front of the product dispenser 100, such that a shaft 158 protrudes through a shaft aperture to gain entrance into the storage chamber 130. The agitator motor 128 is at an angle complementary to the cold plate 125, and may be any form of torque creation device, including stepper motors, alternating current motors, and the like. The agitator motor 128 may further include provisions for attachment to the frame assembly 112.

The paddlewheel 127 is of a commonly utilized design that portions ice particles and moves the portions between tangs to a dispensing port 138 disposed in the divider 120. The paddlewheel 127 fits into the cylindrical inset 137 of the divider 120, and over the shaft 158 of the agitator motor 128. In this embodiment, the paddlewheel 127 is a molded component, and may be constructed from any food grade resin. The agitator bar 129 is constructed from stainless steel, and includes a shaft 156 and multiple shoes 155 disposed on legs 154. The shaft 156 extends from the agitator motor 128 to a rear wall of the storage chamber 130, and is secured to the shaft 158, such that the paddlewheel 127 is secured in position, and the agitator bar 129 rotates with the paddlewheel 127 and the shaft 158 when the agitator motor 128 is powered. The legs 154 are of a length sufficient to bring the shoes 155 in close proximity to an inner surface of the cylindrical section 131 of the divider 120.

In this embodiment, the cold plate 125 is of an aluminum construction with product lines cast directly into the aluminum. The size of the cold plate 125 may vary with the amount of cooling desired in the product dispenser 100. The shroud 120 and the cold plate 125 may further be surrounded by an insulation to insulate and protect the components of the product dispenser 100.

As shown in FIG. 3a, a diluent line 143 from the diluent flow circuit 105 and a concentrate line 140 from the concentrate flow circuit 106 pass through the cold plate 125. The diluent line 143 includes an inlet 144 and an outlet 145, and the concentrate line 140 includes an inlet 141 and an outlet 142. In this embodiment, both inlets 141 and 144 protrude from the inlet portion 135 of the cold plate 125, and both outlets 142 and 145 protrude from the outlet portion 136. The concentrate line 140 and the diluent line 143 make multiple runs within the cold plate 125 to increase the length of the cooling loop in contact with the cold plate 125. FIG. 3b provides a section view of a cold plate including product lines 140 and 143, and a carbonator 147 disposed within the cold plate 125. Embodiments including a carbonator 147 disposed in the cold plate 125 may be treated identically to those without a carbonator 147. As shown in FIGS. 3a and 3b, a dividing line between the inlet portion 135 and the outlet portion 136 is substantially down a midplane of the cold plate 125. While this embodiment discloses a midplane of the cold plate 125 as the dividing line between the inlet portion 135 and the outlet portion 136, one of ordinary skill in the art will recognize that the dividing line may be located at substantially any plane between the inlet portion 135 and the outlet portion 136, dependent upon specific cooling requirements and capacities. Illustratively, the trailing end of the inlet portion 135 may lie within a first third to a half of the cold plate 125.

As previously disclosed, the inlet portion 135 typically is at a temperature higher than the outlet portion 136, because it accepts fluids that are stored at room temperatures. Illustratively, the inletting fluids may be within the range of seventy degrees to ninety degrees Fahrenheit. Alternatively, the outlet portion 136 must dispense fluids at temperatures between thirty and forty degrees Fahrenheit, thereby forcing a temperature gradient across the cold plate 125. As such, the inlet portion 135 and outlet portion 136 are at different temperatures, and ice dispersed onto an upper surface 152 of the cold plate 125 melts at different rates, dependent upon its location on the upper surface 152 of the cold plate 125. Accordingly, the upper surface 152 of the cold plate 125 may be divided into an inlet zone 150 disposed over the inlet portion 135, and an outlet zone 160 disposed over the outlet portion 136.

The diluent flow circuit 105 is connected to a diluent source. A diluent enters the diluent flow circuit 105 through the diluent inlet 144, passes through the runs of the diluent line 143 disposed in the cold plate 125. The diluent then exits the cold plate 125, and moves upward toward the product valve 114. The diluent outlet 145 is connected to a diluent inlet port of the product valve 114 for delivery to the nozzle 122. The product dispenser 100 may further include multiple diluent flow circuits if additional product valves are utilized.

The concentrate flow circuit 106 is connected to a product source. The product source may contain either a full strength or a concentrated product. The product enters the concentrate flow circuit 106 through the concentrate inlet 141 of the concentrate line 140, and passes through the runs within the cold plate 125. Upon exiting the cold plate 125, the product flows through the concentrate line 140 upward toward the product valve 114. The concentrate outlet 142 is connected to a concentrate inlet port of the product valve 114, and therefore, delivers the product to the concentrate inlet port of the product valve 114 for delivery to the nozzle 122. Upon actuation of the product valve 114, a diluent stream and a concentrate stream are delivered through the nozzle 122 for mixing.

In use, ice is delivered to the storage chamber 130 through the open portion of the product dispenser 100. As ice fills the storage chamber 130, portions of the ice fall through the recharge apertures 165 and 170, thereby landing on the upper surface 152 of the cold plate 125. Upon an ice dispense command, the agitator motor 128 is powered, thereby rotating the shaft 158, the paddlewheel 127, and the agitator bar 129. Rotation of the agitator bar 129 moves the legs 154 and the shoes 155 of the agitator bar 129 through ice stored within the storage chamber 130, and pushes ice disposed near the recharge apertures 165 and 170, through the recharge apertures 165 and 170. In this manner, ice continues to move through the recharge apertures 165 and 170, and into the volume directly below the divider 120, and above the cold plate 125.

Ice may build in the volume directly above the cold plate 125 if the cooling demands are low, and will eventually form a blanket of ice approximately six inches thick on the upper surface 152 of the cold plate 125. Ice directly in contact with the cold plate 125 melts as heat is transferred from the cold plate 125 to the ice, and the melting ice is replaced by ice particles directly above the melting ice. In this manner, the ice blanket is continually depleted adjacent to the cold plate 125, and then recharged by ice being forced through the recharge apertures 165 and 170, and onto the outer layers of the ice blanket. As previously disclosed, ice disposed onto the inlet zone 150 melts at an increased rate, and therefore, must be replenished at an increased rate to continually remove heat from the cold plate 125.

The increased area of the input zone recharge aperture 165 allows more ice to be delivered through the input zone recharge aperture 165 to compensate for the increased ice depletion due to the higher temperatures of the inlet portion 135 of the cold plate 125. Incoming fluids routinely enter the cold plate 125 at ambient temperature, and then must be chilled in the cold plate 125. Accordingly, an increased ice flow to the inlet portion 135 is necessary to reach a steady state that is capable of delivering drink dispenses within a prescribed temperature range over extended periods. Upon reaching an equilibrium state, the cold plate 125 is cooled to the point where fluids leaving the cold plate 125 move to the product valve 114 and are delivered within the prescribed temperature range of thirty to forty degrees Fahrenheit.

As disclosed in the first embodiment, one of ordinary skill in the art will recognize that many variables may affect the cooling requirements and capacities of the cold plate 125, including the size of the cold plate 125, the temperature of the fluids entering the cold plate 125, the length of cooling loops disposed within the cold plate 125, the desired temperature of the fluids exiting the cold plate 125, as well as the amount of ice delivered to cool the cold plate 125.

Illustratively, the inletting of fluids at ambient temperatures, approximately seventy degrees Fahrenheit, to the inlet zone 150 of the cold plate 125 raises the temperature of the inlet portion 135, as well as the average temperature of the cold plate 125. The inletting fluids then move through the cold plate 125 to the outlet portion 136 as ice is directed onto the upper surface 152 of the cold plate 125. As previously disclosed, the fluids outlet from the outlet portion 136 of the cold plate 125 exit at temperatures in the range of thirty to forty degrees Fahrenheit. The ice disposed on the upper surface 152 of the cold plate 125 melts as heat is transferred to the ice blanket. As the inlet portion 135 of the cold plate 125 is at a greater temperature than the outlet portion 136 of the cold plate 125, an increased amount of ice is melted above the inlet portion 135 of the cold plate 125, and accordingly, must be replaced at an increased rate. At ambient temperatures, the amount of ice delivered to the inlet portion 135 is increased up to approximately one hundred and twenty-five percent the amount delivered to the outlet portion 136 of the cold plate 125. The increased area of the inlet zone recharge apertures 165 provides for delivery of increased amounts of ice to the inlet zone 150 of the cold plate 125.

As a second point of reference, the inletting of fluids at elevated temperatures, ninety degrees Fahrenheit, for example, creates an increased temperature differential across the cold plate 125, as the desired outlet fluid temperatures must remain in same temperature range of thirty to forty degrees Fahrenheit. The increased temperature of the inletting fluids and the average temperature of the cold plate 125 further increase the melt rate of the ice disposed atop the upper surface 152 of the cold plate 125, particularly the ice disposed on the inlet zone 150 of cold plate 125. In this second example, the amount of ice delivered at the inlet portion 135 of the cold plate 125 is up to substantially double the amount of ice delivered to the outlet portion 136 of the cold plate 125. In this second example, the inlet zone recharge apertures 165 may be of an increased area to facilitate the increased flow of ice to the inlet zone 150 of the cold plate 125.

While these examples show an increased delivery of ice in the ranges of up to one hundred and twenty five percent, and up to substantially double the amount delivered to the outlet portion 136, one of ordinary skill in the art will recognize that amounts greater than those disclosed are possible, and are therefore considered part of this disclosure.

The diluent flows from the diluent source through the diluent inlet 144, thereby entering the diluent line 143. The diluent flows through the diluent line 143, and enters the cold plate 125 with the diluent line 143. The diluent is then chilled as it moves through the cold plate 125, and exits the cold plate 125 with the diluent line 143. The diluent continues through the diluent line 143 to the diluent inlet port of the product valve 114. Upon a dispense command, the diluent moves through the product valve 114, and is delivered through the nozzle 122, within the prescribed temperature range.

Similarly, the concentrate flows from the concentrate source through the concentrate inlet 141, thereby entering the concentrate line 140. The concentrate flows through the concentrate line 140, and enters the cold plate 125 with the concentrate line 140. The concentrate is then chilled as it moves through the passes of the concentrate line 140 disposed within the cold plate 125, and exits the cold plate 125 with the concentrate line 140. The concentrate continues through the concentrate line 140 to the concentrate inlet port of the product valve 114. Upon a dispense command, the concentrate moves through the product valve 114, and is delivered through the nozzle 122 within the prescribed temperature range.

The process of directing ice onto a cold plate in the product dispenser 100 is virtually identical to the process provided in the method flowchart of FIG. 1c. The process commences with step 10, wherein ice is stored above a cold plate 125. In this embodiment, the cold plate 125 includes an inlet portion 135 for inletting fluids, and an outlet portion 136 that outlets fluids disposed within the cold plate 125. The cold plate 125 further includes an upper surface 152 that is divided into an inlet zone 150 disposed above the inlet portion 135, and an outlet zone 160 disposed above the outlet portion 136. The process continues with step 20, wherein beverage fluids flow from the inlet portion to the outlet portion for chilling. Step 30 provides for delivering increased amounts of ice to the inlet zone 150 through an inlet zone recharge aperture 165 having an increased area, thereby compensating for an increased melt rate. Upon the delivery of increased amounts of ice to the inlet zone 150, the fluids exit the cold plate 125 at temperatures acceptable for consumption, step 40.

While this invention has been shown with an increased area for an inlet zone recharge aperture 165, one of ordinary skill in the art will recognize that the increased area of inlet zone recharge aperture 165 extends to, and includes, multiple inlet zone recharge apertures 165, as well as multiple outlet zone recharge apertures 170, such that a combined area of multiple inlet zone recharge apertures 165 is greater than a combined area of outlet zone recharge apertures 170, thereby providing an increased delivery of ice to the inlet zone 150 of the cold plate 125. It should further be noted that a single recharge aperture 165 or 170 may be utilized opposite multiple recharge apertures 165 or 170. Illustratively, a single inlet zone recharge aperture 165 may be utilized with two outlet zone recharge apertures 170, dependent upon specific cooling requirements.

Although the present invention has been described in terms of the foregoing preferred embodiment, such description has been for exemplary purposes only and, as will be apparent to those of ordinary skill in the art, many alternatives, equivalents, and variations of varying degrees will fall within the scope of the present invention. That scope, accordingly, is not to be limited in any respect by the foregoing detailed description; rather, it is defined only by the claims that follow.

I claim:

1. A product dispenser, comprising:
a housing;
a cold plate disposed in the housing, the cold plate including an inlet zone and an outlet zone; and
a divider separating the housing into a section having the cold plate therein, and an ice storage section, the divider including at least one inlet zone recharge aperture disposed above the inlet zone of the cold plate, and at least one outlet zone recharge aperture disposed above the outlet zone, wherein ice is directed through the recharge apertures from the ice storage section to the cold plate, and further wherein, the at least one inlet zone recharge aperture delivers increased ice flow to the inlet zone of the cold plate.

2. The product dispenser according to claim 1, wherein an area of the at least one inlet zone recharge aperture is greater than an area of the at least one outlet zone recharge aperture.

3. The product dispenser according to claim 1, wherein the divider is a shroud of the product dispenser, wherein the shroud includes a storage chamber for storing ice.

4. The product dispenser according to claim 1, wherein the inlet zone and the outlet zone are disposed on an upper surface of the cold plate.

5. The product dispenser according to claim 4, wherein the inlet zone is disposed above an inlet portion of the cold plate, and further wherein the inlet portion of the cold plate receives inletting fluids.

6. The product dispenser according to claim 4, wherein the outlet zone is disposed above an outlet portion of the cold plate.

7. The product dispenser according to claim 6, wherein the outlet portion of the cold plate outlets fluids.

8. The product dispenser according to claim 1, further comprising:
at least one additional inlet zone recharge aperture, wherein a total area of the inlet zone recharge apertures is greater than a total area of the at least one outlet zone recharge aperture, thereby delivering an increased ice flow to the inlet zone of the cold plate.

9. The product dispenser according to claim 1, further comprising:
at least one additional outlet zone recharge aperture, wherein the total area of the outlet zone recharge apertures is less than the total area of the inlet zone recharge apertures, thereby delivering an increased ice flow to the inlet zone of the cold plate.

10. The product dispenser according to claim 8, further comprising:
at least one additional outlet zone recharge aperture, wherein the total area of the outlet zone recharge apertures is less than the total area of the inlet zone recharge apertures, thereby delivering an increased ice flow to the inlet zone of the cold plate.

11. The product dispenser according to claim 1, wherein the increased ice flow to the inlet zone is up to twenty five percent more than the amount delivered to the outlet zone.

12. The product dispenser according to claim 11, wherein the increased ice flow to the inlet zone is up to substantially double the amount of ice delivered to the outlet zone.

13. The product dispenser according to claim 12, wherein the increased ice flow to the inlet zone is greater than substantially double the amount of ice delivered to the outlet zone.

14. A method of cooling a cold plate, comprising:
a. delivering ice onto an outlet zone of a cold plate, wherein the outlet zone is disposed above an outlet portion that delivers chilled fluids; and
b. delivering a greater amount of ice onto an inlet zone of the cold plate, wherein the inlet zone is disposed above an inlet portion that inlets fluids, thereby compensating for increased temperatures of the inlet portion of the cold plate.

15. The method of claim 14, further comprising:
c. cooling the cold plate to a point wherein beverage fluids delivered from flow circuits disposed within the cold plate are delivered within a prescribed temperature range.

16. The method according to claim 14, wherein the ice delivered to the inlet zone passes through at least one inlet zone recharge aperture.

17. The method according to claim 16, wherein the ice delivered to the outlet zone passes through at least one outlet zone recharge aperture.

18. The product dispenser according to claim 14, wherein the increased ice flow to the inlet zone is up to twenty five percent more than the amount delivered to the outlet zone.

19. The product dispenser according to claim 18, wherein the increased ice flow to the inlet zone is up to substantially double the amount of the delivered to the outlet zone.

20. The product dispenser according to claim 19, wherein the increased ice flow to the inlet zone is greater than substantially double the amount of ice delivered to the outlet zone.

21. A method of distributing ice onto a cold plate to achieve an optimal drink temperature, comprising:
a. storing ice above a divider disposed above a cold plate and within a product dispenser, wherein the divider includes at least one inlet zone recharge aperture for delivering ice to an inlet zone of the cold plate, and at least one outlet zone recharge aperture for delivering ice to an outlet zone of the cold plate, and further wherein, a total area of the inlet zone recharge apertures is greater than a total area of the outlet zone recharge apertures;
b. flowing beverage fluids from an inlet portion to an outlet portion of the cold plate, wherein the beverage fluids are disposed within flow circuits, and further wherein, the inlet zone is disposed above the inlet portion, and the outlet zone is disposed above the outlet portion;
c. delivering ice through the at least one inlet zone recharge aperture and the at least one outlet zone recharge aperture to cool the cold plate, wherein increased amounts of ice are delivered to the inlet zone of the cold plate through the at least one inlet zone recharge aperture of an increased area to compensate for increased melt rates on the inlet zone due to the inletting of fluids at increased temperatures into the inlet portion of the cold plate; and
d. delivering a beverage from the flow circuits within a prescribed temperature range.

22. The product dispenser according to claim 21, wherein the increased ice flow to the inlet zone is up to twenty five percent more than the amount delivered to the outlet zone.

23. The product dispenser according to claim 22, wherein the increased ice flow to the inlet zone is up to substantially double the amount of the delivered to the outlet zone.

24. The product dispenser according to claim 23, wherein the increased ice flow to the inlet zone is greater than substantially double the amount of ice delivered to the outlet zone.

25. The method according to claim 21, wherein the total area of the inlet zone recharge apertures is the sum of the areas of multiple inlet zone recharge apertures disposed above the inlet zone of the cold plate.

26. The method according to claim 21, wherein the total area of the outlet zone recharge aperture is the sum of multiple outlet zone recharge apertures disposed above the outlet zone of the cold plate.
